(19) United States
(12) Patent Application Publication
(10) Pub. No.: US 2005/0027588 A1
(43) Pub. Date: Feb. 3, 2005

(54) Method for certification of edifice plumbing systems

(76) Inventor: Dean E. Current, Thornton, CO (US)

Correspondence Address: LEE G. MEYER, ESQ.;MEYER & ASSOCIATES, LLC, 17462 E. POWERS DRIVE, CENTENNIAL, CO, 80015-3046, US

(21) Appl. No.: 10/628,684

(22) Filed: Jul. 28, 2003

(51) Int. Cl. G06F 17/60

(52) U.S. Cl. 705/11

(57) ABSTRACT

A method for certifying the compliance, building specifications, and/or integrity of a plumbing system including water supply; ground/storm water; and, sewage/drainage systems servicing a building, house or other structure involves ascertaining the updated pluming codes and regulations and/or the updated construction plans which pertain to such system, inspecting the system and reporting the compliance and/or integrity of the system. In one aspect the inspection involves captured video tracings of the system with accompanying data including grade, a mapping of the line location, sizing, branching and breaches of integrity. An inspection device adapted to fit within the lateral branch as well as traverse drains to an appliance and vents is utilized.

### BACKGROUND OF THE INVENTION

1. Field of the Invention

The present invention relates generally to a method for certifying edifice-plumbing systems; and, more particularly, to a method for certifying compliance and integrity of water supply; ground/storm water; and, sewage/drainage systems, which service a building structure.

2. Description of Related Art

Improved real estate is a multi billion-dollar business in the U.S., and is expanding throughout the industrial world. In addition to new construction, there is a substantial re-sell market. With the advent of tract building and refurbishment of older buildings, the need for assuring compliance with building plans, and building codes and ordinances, as well as the integrity of structure, roof, water seepage, electrical wiring, water pipes, sewage, drains, vents and other utilities has become more necessary. In addition, integrity, including operability and functionality of these systems, has become of greater importance.

The construction of multi-million dollar structures, such as high rise office buildings, sports stadiums, multi-purpose complexes, warehouse clubs, apartment complexes, condos, and the like requires financing at the single tier and the multi-tier level. Lenders have become increasingly cautious about underwriting projects, which are not in compliance with codes and/or were not built in accordance with the construction blue prints or plans. Stories of water seepage, concrete crumbling, structural failures, excessive settling, plumbing failures and the like have become commonplace.

Since lenders on improved real estate, usually look to liens on the property to secure the outstanding principal, financial appraisals are mandated for most lending institutions. While it is commonplace to have an appraiser appraise a property to assure the lender/buyer of the value being received, an appraisal or audit of building code compliance and systems integrity is far less commonplace. Inspections for compliance and/or integrity of service systems and embedded utilities are the exception, rather than the rule.

In recent years, both purchasers and lenders have become increasingly aware of the pitfalls involved in buying structures, which are either not built to the plans or are not in compliance with local codes, ordnances, and restrictions. A good example is recent ADA legislation requiring all buildings to meet certain minimum requirements for ingress and egress of the disabled. Although, county commissioners and others responsible for enforcing building codes in a particular area, are required to inspect new construction prior to giving occupancy certificates, with the tremendous increase in both regulations and new starts, these inspections are sometimes less than adequate. In addition, codes under which a building may fall may be from more than one jurisdiction.

Recently, lenders and buyers, especially of previously owned properties, have asked the seller to “certify” or warrant certain aspects of the dwelling; and, more importantly, to warrant their code compliance and integrity including functionality. Builders offer ten-year limited structural warranties on residential homes and roofing warranties as well. This practice shifts the risk of loss to the seller for these items, and the seller can purchase insurance. In order to obtain insurance at reasonable cost, however, inspections are required, and in some cases certifications. With the advent of multi-million dollar structures and residential dwellings priced in the millions of dollars range, inspection and certification of, for example, structure, insulation, roofing, and the like has become more commercially important.

However, the plumbing, including water supply, ground/storm water; sewage/drainage systems, vents, and lateral sewage connects, because of their relative inaccessibility, has heretofore been almost totally ignored. Inaccessibility, changing codes, and lack of coordinated methodology for determining operability and compliance have been among the reasons for this situation. Although, mainline sewer systems are required to be inspected at regular intervals for evidence of damage that impair the static load capacity, the impermeability, and the hydraulic efficiency, no such inspection requirements exist with respect to plumbing which services a particular building.

A growing industry has emerged for insuring and/or inspecting dwellings and other structures for compliance with building specifications including architect's plans and construction blue prints. Government agencies are primarily responsible for assuring code compliance on new structures, but because of complacency, or over work this system has not been effective. Once a system is in place in a completed structure, routine agency inspections are not sufficient to assure the lender or the buyer of compliance.

Increasingly, private engineering companies have been called upon to inspect improved properties (mostly commercial) to determine that the buildings meet certain “building” standards. When entities purchase buildings, including residential housing, sometimes they employ engineers and others to “certify” the structure and other components of that building are sound and free of defects. This is done so that one does not buy another's undisclosed problems.

These private inspections of edifices have primarily been with respect to the above ground structure, which is easily accessible. One area, which heretofore has not been subject to such inspection and certification, is the building plumbing systems including the water supply; ground water/storm sewer; and drainage/sewer from the fixture to the main connect with a municipal or private sewage system.

One reason for this is that water supply piping, storm/ground water systems, drainage/sewer line connections, are not easily inspected; and, therefore, especially in the residential market, are oft times overlooked. Another is the complexity of codes and regulations effecting plumbing systems. Because sewage systems are subterranean and drains, vents, and plumbing generally are buried within the walls or structure of an edifice, they have not been, heretofore, inspected for compliance or functionality as a matter of course. Ever changing codes for specific locals have made the job even more difficult.

On the other hand, all newly constructed main “public” sewer lines are visually inspected to map the lines, verify as-built drawing, and ensure the line has no construction flaws. This inspection process must be completed prior to accepting the line for maintenance by the municipality or sanitation district. Additionally, all manholes are vacuum tested to ensure tightness and prevent future infiltration of storm water and release of sewer odors. This procedure has not, however, been heretofore available for lateral sewer connects or plumbing systems servicing edifices, which are private in nature.

Because of the potential for extensive damage, which can be caused by, for example, sewage back-up into a basement of a building or inadequate grade for drainage in, for example, stadium plumbing, the situation has now drawn more attention. The standard remedy for sewer problems is roto-rooter or the like. Some of these services involve optical inspection of the problem.

Municipal pipeline installations, such as those for sewage, generally comprise a main line having lateral branches extending therefrom, for connecting individual buildings, or structures such as parking garages and the like. Lateral branches may require inspection if, for instance, it is suspected they are damaged. If a lateral branch is damaged, there may be undesirable consequences such as contamination of ground water by leaking sewage, or infiltration of ground water into the sewage pipeline, which subsequently increases the burden on sewage treatment plants. However, locating the damage is a difficult task because lateral branches are usually not straight and may be considerably long (e.g. 100 meters).

As a result, there has sprung-up an industry, which employs devices, which are primarily optical in nature, to scope sewer lines, especially main lines and lateral branches to ascertain the cause of problems or to search for breaches which manifest themselves in different ways. These devices are only used when problems arise. They are specific in nature and do not apply to the entire system. They have not been used heretofore in a method for certifying compliance and/or integrity for the purchaser.

The regular inspection, cleaning and sanitary inspection of plumbing systems in office buildings, hospitals, or large kitchens is well known for preserving the value of the facility. The servicing of a pluming system begins with inspection in order to register the general condition of the system and to determine effective maintenance measures. Mobile inspection robots have been developed for the inspection of narrow and winding conduit and pipes. Inspection units can be used in very small pipe diameters upwards of 150 mm, with an action radius of up to 30 m. In addition, it is in the position to overcome gradients and smaller obstacles without any problem.

Additionally, visual inspections have been performed on sewers lines as a result of line blockages and other sewer related problems. The visual inspection process is critical in the detection and location of needed repairs. With the visual camera, the crew can find the exact location of lateral connection and type of problem. This information is valuable in the digging and repair process as it eliminates digging “guess work.”

In the event damage to a lateral is suspected or detected, miniature inspection devices such as a video camera have been attached to the end of a semi-rigid member, and the camera introduced and pushed into the lateral branch from an access point inside the building. To overcome the above difficulties, apparatus have been proposed for remotely inspecting lateral branches from within a main pipeline when damage is detected. For example, U.S. Pat. No. 4,651,558 to Martin and Guthrie relates to a launcher, which is pulled through a main pipeline using ropes or cables. U.S. Pat. No. 4,677,472 to Wood describes another apparatus for advancing a miniature video camera, fixed to an end of a semi-rigid push rod, into a lateral branch of a pipeline. The apparatus, which is pulled through a main pipeline, employs a pair of motor-driven drive pulleys through which the push rod is advanced into the lateral branch. The pulleys are tiltable and rotatable so that the position from which the video camera is advanced may be aligned with a lateral branch.

However, most inspection systems are employed to determine the extent of suspected damage and/or to determine the extent of known damage. It would be advantageous to have a method that ensures all appropriate standards are being applied and implemented within the edifice and/or in the construction process; that provides an efficient, effective and uniform system of certification of edifice pluming systems including inspections and reporting that provides an effective outcome for minimum cost; and, that provides a high level uniformity to inspire public confidence in the certification process such that it can be relied upon as a standard in the real estate, insurance, financial, and construction industry.

To meet these requirements, it would be advantageous to have a uniform method for certifying edifice plumbing systems which are the subject matter of a sale, financing or other transfer; and, specifically for certifying both plumbing code compliance and/or building plan compliance and/or system integrity of water supply, ground/storm water, sewage/drainage systems which service a building structure. It would be further advantageous to have a certification method, like a financial appraisal, which would enable the purchaser, financier, or occupant to be assured that a pluming system servicing an edifice is currently compliant with plumbing codes and/or was built to building plans and/or has integrity.

### SUMMARY OF THE INVENTION

In accordance with the instant invention, there is provided a method for certifying the Building Code and/or Building Plan compliance and/or integrity of an edifice Plumbing System. The edifices include, for example, office complexes, residential dwellings, sports stadiums, apartment complexes, manufacturing facilities, and the like. The certification of the Plumbing System can be of the water supply and/or the drainage/sewage system and/or the storm/ground water disposal system.

The method comprises establishing a requirement for Plumbing System compliance by, for example, populating a template from, for example, a database which may be manual or comprise a computerized “look up table” containing Plumbing Codes, regulations, and the like for the district or area in which the edifice is located including the zoning restrictions; inspecting the Plumbing System, or parts thereof, to determine, for example, its compliance with the Plumbing Code requirements, accessed from the database, as well as the integrity of the Plumbing System being certified by means of, for example, visual inspection and sensors to determine, for example, conduit layout, draining grade, obstructions, breaches in integrity, and the like; comparing the inspected data against the requirements in the template; and, certifying the compliance (or lack thereof) and the integrity of the Plumbing System. In another aspect, remedial steps for compliance, if possible, are specified.

In accordance with one aspect, the inspection includes recording the inspection data, including accompanying Building Code and/or Building Plans and/or integrity data as a function of time and location within the Plumbing System. In accordance with another aspect, the compliance certification includes certification that the Plumbing System complies with the Building Plans and specifications as contained in the blueprints or the like. In accordance with another aspect, the compliance certification includes certification that the Plumbing System complies with the Building Codes, zoning codes, and regulations as of a specific date, including grand fathered requirements. In accordance with another aspect, a recording accompanies the certification to give the client or customer a visual view of the Pluming System. Notations are contained on the certification, noting potential problem areas of the system or deviations from Building Code and/or Building Plans. Remedial actions to rectify deficiencies and/or obtain compliance can also be included.

In accordance with one embodiment, the drainage/sewage system from the fixtures to the connection with the main sewer line interconnects or septic system is certified. In accordance with another embodiment, the ground water/storm sewer system from the accumulating receptacle to the main sewer line is certified. In accordance with another embodiment the water supply from the main to the fixtures is certified.

The visual inspection of, for example, drains within the building, from vent to main line interconnect, is advantageously accomplished with a device, which records video, time, date, elevation, grade, and property description. In one advantageous embodiment, the inspection tool comprises a multi-lensed camera, a digital distance tracking device, and a plumb-sensor, a date time imager, and the address of the building. Advantageously, the device communicates with a central consol by way of radio-frequency or fiber-optics, and the video recording includes on each frame thereof a date, time, a distance, and an elevation based upon a starting point in the system, and comprises multi-views of the internal periphery, joints, “T”s, and “Y”s of the system.

In another aspect, a Client/Server System is provided, which utilizes a System Transaction Manager to populate a Central Plumbing Code Database from appropriate Governmental Agency/Authority databases or web sites. The Central Plumbing Code Database is used to generate updated Plumbing Code requirements in response to an Update And Mapping Database controlled by a System Administrator. Structure Plumbing System Certification Requirements, including grand fathered provision, are generated for an edifice to be certified. Updated Building Plans can also be used to update the Structure Certification Requirements.

The certification includes comparing the information produced to determine the compliance of the Structure Pluming Certification Requirements with Building Code, and/or Building Plans and/or the integrity of the system, including functionality and/or operability; and, certifying to the owner, buyer, mortgagee, and/or realtor the condition of the system predicated upon the generated edifice Plumbing System requirements to verify the compliance (or non-compliance) and integrity of the system including identifying of non compliance and/or defects, if any.

### BRIEF DESCRIPTION OF THE DRAWINGS

The following drawings form part of the present specification and are included to further demonstrate certain embodiments. These embodiments may be better understood by reference to one or more of these drawings in combination with the detailed description of specific embodiments presented herein.

FIG. 1 is a flow chart of the steps of the method of the instant invention; and,

FIG. 2 is a flow chart of the automated system for establishing edifice Plumbing Code requirements in accordance with the instant invention.

### DETAILED DESCRIPTION OF THE PREFERRED EMBODIMENTS

According to the invention, there is provided a uniform protocol or business methodology for non-governmental, fee-paid certification of edifice Plumbing Systems to provide the client with a “certification” of regulatory compliance with Plumbing Codes, and/or Building Plans, as well as the integrity of the Plumbing System. This certification pertains to “Plumbing Systems.” As used herein the term “Plumbing System” is meant to include drainage/sewage system from the fixtures to the connection with the main sewer line interconnect or septic system; the ground water/storm sewer system from, for example, the accumulating receptacle to the main storm sewer line; the water supply from the water main to the fixtures; and any or all of them.

The certification applies in one aspect to compliance with “Plumbing Codes.” As used herein, the term “Plumbing Codes” is meant to include plumbing codes and/or plumbing regulations and/or ordinances for district, county, or other area having authority and control over edifice Plumbing Systems and including zoning codes as they effect Pluming Code compliance including updates and “grand fathering” of the above, which regulations, codes, and ordinances govern the installation, and performance of Plumbing Systems at a specific time or, any of them or all of them. In another aspect, the certification applies to compliance with Building Plans. As used herein, the term “Building Plans” is meant to include detailed architectural blue prints, plans, and specifications relating to the construction of an edifice, the renovations, modifications, and reworks thereof; and, specifically, such drawings, plans, and specifications relating to the Plumbing System for such building or structure.

The principal aspects of the inventive certification method is summarized as follows: ensure all appropriate standards/specifications are being applied and implemented within the edifice and/or in the construction process; provide an efficient, effective and uniform system of certification of edifice Pluming Systems including inspections and reporting that ensures an effective outcome for minimum cost; and, provide a high level of uniformity to inspire public confidence in the certification process such that it can be relied upon as a standard in the real estate, financial, and construction industry.

The above criteria provide a basis for certification of Plumbing Systems as discussed below. In accordance with one aspect of the instant invention, there is provided a detailed method for the certification of embedded Pluming Systems for buildings, wherein a database of Plumbing Codes and regulations relating to Pluming System's installation for particular locals, political subdivisions, sanitation and water districts, zoning restrictions, and the like is first generated. Using the data, a certification criteria template is populated, which relates to a particular building or edifice to be inspected and certified. The database can be specific to those aspects of the Plumbing Systems being inspected and certified, or can be more general in nature such as all similarly zoned building in a sanitation district.

The inspection can include, for example, determining the functionality of fixtures external to the walls of the structure, such as toilets, water heater, facets, tub drain closures, water spickets, and the like. An internal inspection of drainage piping, sewage connects, and venting can then be undertaken, as further described below. During this internal inspection video recordation can be accomplished simultaneously with, for example, GPS locators, elevation, and grade sensors. In accordance with one aspect of the invention, pressure testing and/or water confluence is used to determine the integrity of the Plumbing System, including the lateral sewage interconnect. Once the inspection is accomplished, the information is interfaced and compared with the template to produce a plumbing certification. The plumbing certification includes, not only the functionality of fixtures and interconnecting piping including drains, vents, sewage, and sewage lateral interconnect, but also compliance of materials, quality, and placement of fixtures and interconnecting drainage and sewage systems with site specific Plumbing Code and regulations derived from the table. Anomalous events and readings are reported as part of the certification. In another aspect, remedial measures are indicated to bring anomalies into code or functional compliance as part of the compliance certification.

In accordance with the invention, there is provided a four-step method for certifying the Plumbing System of a structure. In a first step site-specific building related plumbing data is collected, which constitutes the requirements for the Plumbing Code to be inspected. This includes Plumbing Codes and/or Building Plans. When Plumbing Codes are used, the codes for a particular authority and/or district are isolated as a function of applicable time frames, including zoning requirements and updates. Some aspects of the Plumbing System are grand fathered, while others are subject to upgrade and/or update. The updated Building Plans are normally used as an input to the code requirement to determine remodeling or renovation that would subject the structure to the new codes or regulations.

In a second step the Plumbing System is inspected. This can include visual “walk around” inspection, as well as internal inspection of the Plumbing System as further described below. In a third step, the information derived from the inspection is compared to the requirements generated in the first step and deficiencies and differences noted. In addition, if required, system integrity issues are noted, all as set forth below. Finally the Plumbing System is certified, including identifying non-compliance and/or integrity issues. In one embodiment, remedial actions are set forth to bring non-compliance Pluming Systems into compliance or remedy integrity issues, if possible.

In accordance with one aspect, the water supply system is certified against updated Plumbing Code requirements for water supply systems within a particular local and/or region and/or water district having specific zoning. In addition, the integrity of the water supply system from the water main, or water source, throughout the edifice is certified for integrity, functionality, and operability. This includes determining whether delivery conduits and fittings meet code and/or regulations. Further, functional requirements such as conduit material, installation methods, and freeze protection are assessed. The integrity of the system includes inspection for leaks, blockages, and operability of fixtures such as facets and the like, and can include outdoor irrigation including hose bibs, sprinkler mains, and the like.

Sewage/drain certification can include compliance with local Plumbing Codes and regulations of drains, sewers, and vents within the edifice, as well as sewage connection with the main sewer line. Integrity of the sewage/drain system includes visual inspection for obstruction, drainage grade, and operability of traps, vents, and/or clean-outs. Storm water/drainage system compliance includes visual inspection for obstruction, drainage grade, and operability of cisterns and the like. In another aspect, determination of compliance with Building Plans and specifications is assessed and certified.

Establishment of the Requirements for Plumbing Systems Applicable to a Structure

In accordance with the invention, the initial step in certification of a Plumbing System is establishing a criteria or requirement which a particular structure Plumbing System must meet in order to be certified without exceptions. Plumbing Codes provide one set of requirements and are specific to, not only various geographical areas, but also to a specific type of structure. These structures are usually categorized in accordance with the zoning requirements for a particular geographic location, but need not be. Plumbing Codes for residential zones, industrial zones and commercial zones are in many cases different.

Plumbing Codes relate to requirements of the water supply system, sewage system, and storm water/drainage system. The Plumbing Codes can be different for commercial, industrial, and residential structures. In addition, the Plumbing Codes are updated and changed as a function of time. Thus, for example, a commercial structure, built in the 1960s, has different code requirements than those built in the 1990s. Thus, in establishing requirements for a specific building the date of construction, as well as any required updates for the structure, are used. In many instances buildings are “grand fathered” and the Plumbing System is not required to be updated unless and until major renovations, for example, requiring a building permit, to be applied for.

Many of the Building Code requirements for industrial or commercial buildings relate to the number of facilities per unit, or the number of persons occupying the facility or a portion thereof. In this case, compliance is easily observed, for example, one men's bathroom on each floor having four urinals, three stalls (commodes), and three lavatories. In these cases the inspection involves observations on a walking tour. Residential requirements usually relate to the whole structure. Plumbing Codes, including subdivision requirements and the like, may relate to individual drains, commodes, and facilities in a single-family dwelling. Other Plumbing Codes relate to requirements of the Pluming System, which are only observable with the use of certain diagnostic equipment, which may be optical, positional, elevational, or the like. As will be later described, these tools or devices are required to inspect otherwise inaccessible places to assure compliance with Plumbing Codes and/or Building Plans.

In another aspect, the established requirements include Building Plans for new and renovated structures. In this aspect, the architects' plumbing/utility plans indicate placement, load requirements, drainage grades, and quality of materials to be used. In certifying a Plumbing System in respect to the Building Plans and specifications all aspects of the Plumbing System in the structure need be inspected, including placement of drains, sewage interconnect, flow, drainage grade and the like. In most cases, Plumbing Codes need to be updated for a particular structure by use of the Building Plans as modified.

Population of the Certification Template-Plumbing Code Database

In order to populate a template to be used in accordance with the method of the instant invention, preferably a database is first compiled comprising Plumbing Codes and regulations for specific locals, counties, building districts, sewage districts, zoning, and the like, so that, for example, identifying an edifice by GPS coordinates or ZIP code will allow a search to determine the Plumbing Code and regulation applicable to the Plumbing System of that site. In one embodiment, the database is accessible by means of the Internet, and is maintained and updated on at least one centralized server. In this manner, Building Codes and regulations promulgated by an agency, political entity, sanitation district, water district, county commissioners, or the like can be used to update the table in accordance with the instant invention. In many cases the database can be populated by access to the appropriate authority web sites that list the codes. This methodology will be further described below.

It will be realized by the skilled artisan that population of this look-up table may comprise multi-facets depending upon the utility and the age of the edifice to be certified. For example, certain plot plans approved by county commissioners may involve exemptions from certain regulations while the existence of an edifice to be certified within an incorporated city limit may add particular requirements to all structures having specific zoning. Thus, the look-up table of this embodiment of the instant invention can be multi-faceted. Updates from modification and/or renovation of structure Building Plans may also be required to determine the exact Plumbing Codes to specify.

It will be realized that other methods of establishing requirements and criteria are useful in accordance with the instant invention. Population of a template in order to certify a Plumbing System in accordance with the instant invention is but one method for establishing such requirements. Other methods include manual tables, association manuals, and pamphlets or obtaining codes and/or requirements directly from agencies, municipalities, and the like. Once the template is populated with the particular codes and/or requirements, which relate to the structure or edifice to be certified, then the Plumbing System is inspected to determine compliance with the requirements, as well as to determine inherent integrity, functionality, and operability of the specific system as will be further described.

Inspection of Plumbing Systems

In accordance with the invention, inspection of the Plumbing System is a function of the criteria to be certified and the functionality of the structure. Inspection for compliance with Plumbing Codes may require one set of methodology, while those for Building Plans another. In accordance with one aspect, primarily used for large commercial structures and/or high-rise apartment and condominium complexes, a pipe-line mapping system can be utilized, which includes, for example, a mapping probe on a probe conveyor, which is extendable into a lateral pipe-line or conduit system. The probe conveyor can be any known in the art including flexible push rods, water jet impellors, and/or electric motors, which can be, for example, battery operated.

In an advantageous aspect, the mapping probe contains at least one lens for capturing video of the interior of the pipeline or conduit. The lens can be for an electronic, conventional, or digital camera and include optics for video recording. In accordance with this embodiment, multi-lens video cameras are carried on the mapping probe and convey via hard wire or radio frequency signal, which is captured at a command station or the like to be further described below. In accordance with one aspect, the probe carries a leveling sensor connected to a transducer or the like, to determine grade, as well as help determine location. GPS based locator systems help map the Plumbing Systems to determine compliance with plans, specifications, and the like. It will be realized by the skilled artisan that other sensors and inspection devices can be utilized in conjunction with the above described mapping system.

Pressure integrity tests, which are known in the art, can be conducted to determine system integrity. Breaches in pipeline and conduit structure can be determined both optically and by means of such pressure or fluid tests. Once the data from the mapping system is collected at a command system, then various aspects of data are captured. For example, video frames carrying time, direction, grade, and GPS information can be recorded on VHS, CD, electronic chip, or the like. Once this data is captured in recordable or electronic form, then it is manipulated for comparison with the requirements gathered in, for example, the populated template, and a compliance record generated. This can be accomplished manually or by means of computerized software.

In accordance with the invention, there are number of inspection devices, which can be used to gain Plumbing System information for comparison. For example, U.S. 2002/0113869 A1 application to Kirkwood, which is incorporated herein by reference, discloses a pipeline mapping system and method. Another example is disclosed in U.S. Re. 33,160 to Guthrie et al., for a method and apparatus for inspecting lateral lines, which is incorporated herein by reference. Likewise, U.S. Pat. No. 6,313,869 to Hyp et al. discloses a nozzle articulating camera system for inspecting feed water piping and water supply generally, which is incorporated herein by reference. Another example of a useful inspection system is disclosed in U.S. Pat. No. 6,505,525 to McGrew, for an apparatus and method for inspecting lateral sewer pipes, which is incorporated herein by reference.

In addition, there exist a number of mini-cam video inspection systems and/or monitors for inspecting sewage/drainage systems, water supply systems, and ground water/storm system inspection devices. For example, those sold by “My Tanna Corporation” and those devices such as the ARIES® pipeline television inspection, test, and seal systems, sold by Aries Industries, Inc. are useful in accordance with the inspection step of the invention. It will be realized by the skilled artisan that a number of such audio, visual, hydraulic, hydrostatic, and even x-ray devices are available in the art. The Plumbing Codes will determine the use of these devices in a particular certification application.

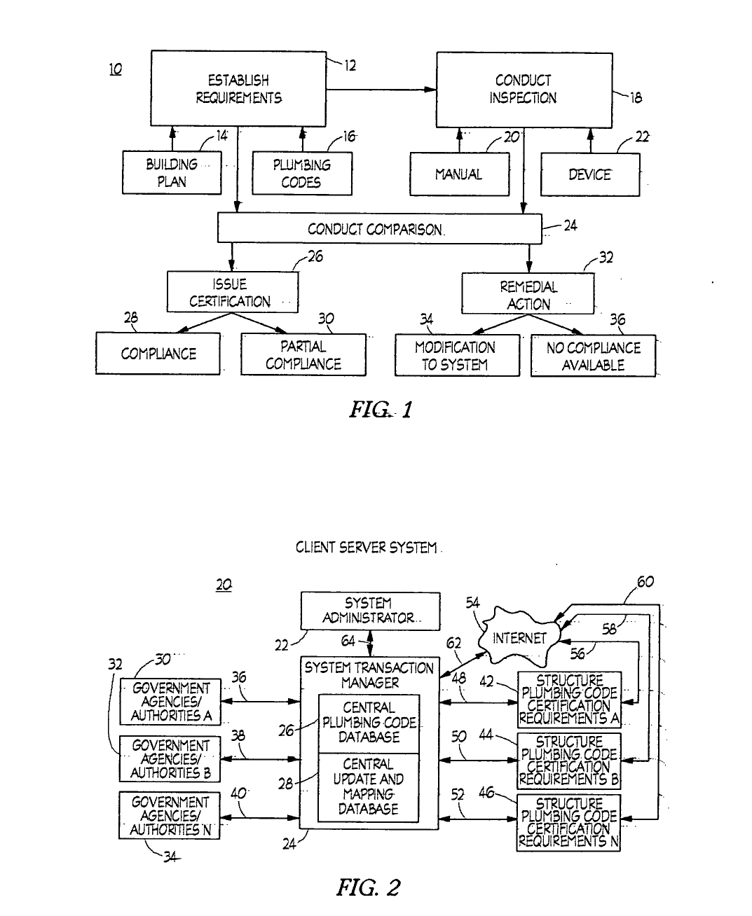

Turning now to the drawings, there is shown in FIG. 1 a flow chart 10, in accordance with the method of the instant invention for certifying a Plumbing System. In a first step, system requirements 12 are established using Building Plan 14, Plumbing Codes 16, and/or a combination thereof. When Building Plans are utilized to establish the system requirements 12 in accordance with the instant invention, the building blue prints and architectural drawings for the specific structure to be certified are obtained from, for example, the client, the architect, the building owner, or the like. These plans and specifications could comprise blue prints, utility drawings, or the like.

In accordance with the method, a first set of such plans are the “as built” blue prints with modifications, additions, renovations, and the like representing modifications to the original blue prints. The dates of such modifications are also advantageously established to allow interface with Plumbing Codes 16, as it will be further described. Thus, for example, in the case of an office building where individual tenants through out the years have requested modification to a suite or office space including the connecting Plumbing System, the plans for these modifications, if still in existence need to be acquired as part of establishing the requirements. It will be realized by the skilled artisan that in many cases such “build-outs” will not necessitate certification, because of the temporary nature of such facilities. However, in other cases, these facilities will be included in the certification.

The Building Plans should include, depending on the requirements for the certification, water supply, ground water/storm sewer, sewage/drainage systems with complete lateral sewage lines which service a building structure, including location of sewer and drainage lines within bearing and non-bearing walls, utility corridors, and the like. In addition, all vents, traps, and plumbing facilities, such as lavatories, commodes, showers, tubs, urinals, and the like, can be specified. Additionally, water supply lines and location including upgrades, renovations, and the like, can be specified. Further, all ground water/storm sewer systems, including cisterns, interconnect and environmental compliance equipment can be specified.

In accordance with the Building Plans requirements, quality of material and of facilities are specified; so that their compliance can be determined upon inspection as set forth bellow. In addition, location of common facilities, such as public restrooms, utility closets, such as janitorial closets (with plumbing), floor drains, and the like can be specified. It will be realized by the skilled artisan that the level of detail required in establishing the requirements using the Building Plan will depend upon the scope of certification required.

The requirements 12 can also be established by use of Plumbing Codes 16, either alone or in conjunction with Building Plans 14. In accordance with this aspect, Plumbing Codes 16, which relate to the structure according to its built date, zoning and the like, are first collected in tabularized, preferably through a computer look-up table as more specifically set forth in FIG. 2. All updates and revisions to the codes, regulations, and the like of any governing authority, including, for example, homeowners association, are then overlaid on the original data as a function of effective date, to develop final Plumbing Code requirements for the structure to be certified in accordance with the invention. Finally, a determination of “grand fathering” of new codes and regulations as applied to the “as built” structure and those codes applicable to upgrades, renovations, and the like are applied to determine a set of requirements, which are used in accordance with the method of certification.

Site-specific Plumbing Codes 16 are acquired by use of, for example, building address, GPS location, and/or ZIP codes. The Plumbing Codes 16 requirements can be gathered into a central database using, for example, various web sites of governing bodies to populate a central database. Plumbing Codes are then addressed in the central database by means of such locations, as is more specifically set forth below. In this manner, as will be further described, a central Plumbing Codes requirements database is formed for a number of locations, i.e. the state of Colorado; and, addressed according to the GPS location and/or ZIP codes, such that a structure in a particular location and/or ZIP code can be accessed by postal address to populate the specific requirements for a particular structure as a function of building dates, zoning, upgrade dates, renovation dates, and the like.

Once requirements 12 are established for a particular structure to be certified, including all of the corrections and variations as above described, the structure's Plumbing System is inspected. As seen in FIG. 1, established requirements 12 are used in determining the proper devices and methods for conducting the inspection, i.e. inspection 18 is conducted against the established requirements for the structure to be certified. As set forth above, inspection 18 can be conducted by means of a manual inspection 20 and/or a device inspection 22, depending on the requirements for the certification. In most cases a combination of these methods is required in order to accomplished a complete certification. However, it will be realized by a skilled artisan that “partial” or component certifications can be accomplished in accordance with the method of the instant invention. For example, certification of all lateral and connecting sewage drains and vents can be accomplished substantially only by device inspection.

Manual inspection 20 is accomplished by “walk through” of the structure, noting the quality, quantity, and position of various plumbing facilities including, for example, public restroom, janitorial closets, floor drains, and the like. In the case residential structures, lavatory, commode, tub, and shower placements are noted as well as their condition and quality. Leakage and other visual impairments to the structure caused by the Plumbing System are also able of detection, to some extent, by manual inspection. When the certification requires Building Plan 14 compliance and Plumbing Codes 16 compliance, a single manual inspection can be used. In this way deviations from the Building Plan 14 and/or Plumbing Codes 16 can be determined as representing at least one aspect of non-compliance.

The device inspection 22 can employ optical, mechanical, gravitational, pressure, and the like. In accordance with one aspect of the invention, pressure testing and/or water confluence is used to determine the integrity of the Plumbing System, including the lateral sewage interconnect. Examples of the devices used are set forth above. Advantageously, recordings of the device inspection are made for attachment to the certification. For example, recordings containing video with frame imprint of time, date, elevation, grade, and property description are made. The inspection tool can comprise a multi-lensed camera, a digital distance tracking device, and a plumb-sensor, and a date time imager. Advantageously, the device communicates with a central consol by way of radio-frequency or fiber-optics and the video recording includes on each frame thereof a date, time, a distance, and an elevation based upon a starting point in the system, and comprises multi-views of the internal periphery, joints, “T”s, and “Y”s of the system. The device can carry a leveling sensor connected to a transducer or the like, to determine grade as well as help determine location. In one embodiment, GPS based locator systems are used to map the Plumbing Systems to determine compliance with plans, specifications, and the like.

When the inspection 18 is completed, a comparison 24 is made between all requirements 12 necessary for certification, and the information gained from the inspection 18. Once the data inspection is collected at a command system (not shown), then various aspects of data are captured. For example, video frames carrying time, direction, grade, and GPS information can be recorded on VHS, CD, electronic chip, or the like. Once this data is captured in recordable or electronic form, then it is manipulated for comparison with the requirements gathered in for example the populated template and a compliance record generated. This can be accomplished manually or by means of computerized software.

The results of the comparison step 24 are used in issuing certification 26 as shown in FIG. 1. The certification 26 can indicate that the structure is in compliance 28 with the established requirements 12 or is only in partial compliance 30. Partial compliance 30 includes total non-compliance (which is rare). The comparison 24, in addition to certification 26, where the structure is only in partial compliance can yield in accordance with another aspect of the invention remedial actions 32. Such remedial actions are indications of those corrections that need to be made to the structure in order to obtain a certified compliance. In tabulating the remedial action, a list of modifications to the Plumbing System 34 can be listed, which specify the exact nature of the remedial action 32 required to gain compliance 28. If no mere modification to the system will remedy the defect, the certification indicates that no remedial compliance 36 is available.

In accordance with another aspect of the invention an automated system is utilized to establish structural Plumbing Code requirements. Turning to FIG. 2, there is shown an example of a “client/server” type system 20 with Internet interface. The client/server system 20 permits Government Agency/Authority “A,” “B,” and “N” (30, 32, and 34) to link with System Transaction Manager 24. The designation of “N” Government Agencies/Authorities illustrates that any number of Government Agencies/Authorities could be connected to the client/server system 20 of the instant invention. The System Transaction Manager 24 is, for example, computer microprocessor-based equipment residing at one or at multiple locations and is set-up to communicate with the Structure Plumbing Code Certification Requirements “A”, “B”, and “N” (42, 44, and 46) for the required electronic communication.

The System Transaction Manager 24 includes a Central Plumbing Code Database 26 and a Central Update and Mapping Database 28. Communications links 36, 38, and 40 functionally connect the Government Agencies/Authorities 30, 32, and 34, respectively, to the System Transaction Manager 24 by, for example, dial-up networking, Digital Subscriber Lines (“DSL”), Asymmetric Digital Subscriber Lines (“ADSL”), Virtual Private Network (“VPN”), cable, wireless technology such as IR, radio frequency, cell, and satellite, or any other high speed connection as made available by technological advances in communication systems and as practiced by those skilled in the relevant arts.

A System Administrator 22 sets client/server system 20 policy and interfaces with the System Transaction Manager 24 through link 64. Established Structure Plumbing Code Certification Requirements (designated A, B, and N to indicate any number of stations in the system) 42, 44, and 46 communicate with the System Transaction Manager 24 via communications links 48, 50, and 52 respectively, as well as through the Internet 54 by means of Internet communication links 56, 58, and 60, respectively. Internet 54 likewise communicates with the System Transaction Manager 24 by means of Internet connection 62.

The System Transaction Manager 24 operates the data flow in client/server system 20 in accordance with policy as set by the System Administrator 22. Information data within Central Plumbing Code Database 26 is indexed to provide System Transaction Manager 24 instructions for populating and managing information data to and from Structure Plumbing Code Certification Requirements 42, 44, and 46 via communication links 48, 50, and 52. Central Update and Mapping Database 28 contains mapping information, such that a particular structure address can access all Plumbing Codes required for certification. Central Update and Mapping Database 28 also contains a zoning look up table, which is updated and administered by the Systems Administrator 22. Central Update and Mapping Database 28 also contains operating protocol for the system 20, which is associated with indexed information data contained in the Central Plumbing Code Database 26.

Thus, the System Transaction Manager 24, in accordance with the indexed data, initially updates the information in the Central Plumbing Code Database 26 and specifies the information required to populate Structure Plumbing Codes Certification Requirements 42, 44, and 46 with layered, location specific data. Along with the information, the System Transaction Manager 24 downloads appropriate operating protocol, again based on indexing, to render Structure Plumbing Codes Certification Requirements 42, 44, and 46 operative. The protocol is authored to perform a myriad of functions. Communication links 48, 50, and 52 are active and the System Transaction Manager 24 can address and interact with the Structure Plumbing Codes Certification Requirements 42, 44, and 46 which are each populated for a different structure as indexed by its street address and/or the GPS location. This interaction includes monitoring transactions, allowing third party interface, and the like.

Government Agencies/Authorities 30, 32, and 34 are used to populate the client/server system 20. Each Government Agency/Authority represents Plumbing Codes and regulation that effect structures in their jurisdiction, usually as a function of date. If not, the Updating and Mapping Database 28 archives of the previous Plumbing Codes are used. The dated information on each Government Agency/Authority site, as previously described, is transmitted via data links 36, 38, and 40 to the System Transaction Manager 24. The System Transaction Manager 24, with appropriate data identification, prioritizes the information in accordance with the policy set by System Administrator 22 for storage, indexing and then stores the information retrieved from the Government Agency/Authority in the Central Plumbing Code Database 26. In addition, a trigger is set, if any of the retrieved information is new, and Updating and Mapping Database 28 is updated with the previous information being archived by date, for retrieval as set forth above.

The System Transaction Manager 24 tests the Structure Plumbing Codes Certification Requirements index to determine dates, street address, renovations, and the like and then gathers the updated information from the Central Plumbing Code Database 26 and populates the Structure Plumbing Codes Certification Requirements by means of data links 48, 50, and 52. The population protocol and, for example, grand fathering aspects are likewise transmitted in accordance with policies set by the Systems Administrator 22. If there are conflicting Plumbing Codes requirements received by any Structure Plumbing Codes Certification Requirements, then an error flag is send to the System Administrator 22 for special handling.

As shown in FIG. 2, the client/server system 20 also provides access to Structure Plumbing Code Certification Requirements 42, 44, and 46 via the Internet 54. Internet 54 is linked to Structure Plumbing Code Certification Requirements 42, 44, and 46 by means of links 56, 58, and 60, respectively. System Transaction Manager 24 is also connected to the Internet 54 via link 62. In addition to the links 48, 50, and 52, links are also provided through the Internet 54, as described, such that System Transaction Manager 24 can directly access Structure Plumbing Code Certification Requirements 42, 44, and 46 through the Internet 54. In accordance with this embodiment, System Transaction Manager 24 via links 48, 50, and 52 or via link 62 to the Internet 54 by way of links of 56, 58, and 60 can populate Structure Plumbing Code Certification Requirements 42, 44, and 46.

It will be realized that, in accordance with this embodiment, the System Transaction Manager has control over Internet access to all Structure Plumbing Code Certification Requirements. The Normalized Data Format used by the present invention can be any well-known data formatting protocol. For example, the Normalized Data Format can be the eXtended markup language (XML). Alternatively, for the systems of the present invention that link together the constituent users over the Internet, the Normalized Data Format can be FTP, TCP/IP, or http standard used on the Internet.

In operation, the System Transaction Manager 24 reads and logs the Government Agency/Authority information; assigns an application protocol, depending on the dissemination rule triggered by the System Administrator 22; and, assigns a dated ID for tracking purposes. In this manner, the Government Agency/Authority information, that is acknowledged, is moved to the Central Plumbing Code Database; noted as a “completed transaction”; and, catalogued. This update is likewise transferred to the Central Update and Mapping Database as a function of when the code was promulgated and the grand fathering “exception” set, if appropriate, based upon the policy of the System Administrator as previously described. The System Transaction Manager 24 then, prepares the Government Agency/Authority information with the updated information for routing to a Structure Plumbing Code Certification Requirements to generate the Structure Plumbing Code Certification Requirements for the street addressed structure.

In one aspect, the System Transaction Manager provides an “industry application programming interface” for developed programs, which allows Government Agency/Authorities to be able to interface directly with the client/server system. In this manner, the Central Plumbing Codes database is continually updated with information from the Government Agency/Authorities. In one aspect, the communications link is a private secure link. In accordance with another aspect, the communications link is a pre-existing, public system such as the Internet. In accordance with an advantageous embodiment contemplated herein, a single centralized System Transaction Manager is provided. In another embodiment, a plurality of System Transaction Managers communicate with the Structure Plumbing Code Certification Requirements and in turn with a central System Transaction Manager in a multi-tiered system.

Status information, indicating a Structure Plumbing Code Certification Requirements request to the system, as well as a bit flags containing information as to what processing remains to complete the population of the Structure Plumbing Code Certification Requirements, is contained in a subset in the Structure Plumbing Code Certification Requirements to allow for rapid transmission of status information back to the System Transaction Manager for both operability confirmation, as well as progress indication. Index codes are used by the System Transaction Manager to uniquely log and identify each Structure Plumbing Code Certification Requirements status.

The foregoing discussions, and examples, describe only specific embodiments of the present invention. It should be understood that a number of changes might be made, without departing from its essence. In this regard, it is intended that such changes—to the extent that they achieve substantially the same result, in substantially the same way—would still fall within the scope and spirit of the present invention.

1. A method for certifying the plumbing system of a structure comprising:
(a) establishing requirements for plumbing systems applicable to said structure;
(b) inspecting the plumbing system of the structure to produce information relative to said requirements;
(c) comparing the requirements for said plumbing systems to said produced information to determine the degree of compliance; and,
(d) certifying the compliance of said pluming system with said information including indication that the system is in total or partial non-compliance.

2. The method for certifying the plumbing system of a structure of claim 1 wherein said requirements are selected from a group consisting of building plumbing codes, building plans, and combinations thereof

3. The method for certifying the plumbing system of a structure of claim 1 wherein said pluming system is selected from a group consisting of water supply systems, ground/storm water systems, sewage/drainage systems, and combinations thereof

4. The method for certifying the plumbing system of a structure of claim 1 wherein said establishing step includes, in part, populating a template with plumbing codes in the area in which the structure is located.

5. The method for certifying the plumbing system of a structure of claim 4 wherein said establishing step includes, in part, populating a template with plumbing codes in the area in which the structure is located at the time the structure was erected and updates thereto applicable to said structure.

6. The method for certifying the plumbing system of a structure of claim 1 wherein said inspecting step includes a visual inspection.

7. The method for certifying the plumbing system of a structure of claim 6 wherein said visual inspection is carried out by device for visual recording.

8. The method for certifying the plumbing system of a structure of claim 6 wherein said inspecting step further includes the use of sensors comprising pressure sensors, magnetic sensors, directional sensors, toxic gas sensors, hydrologic sensors, and combinations thereof.

9. The method for certifying the plumbing system of a structure of claim 8 wherein said inspection includes determination of conduit layout, grade obstructions, breaches in integrity and combinations thereof

10. The method for certifying the plumbing system of a structure of claim 1 wherein said inspecting step includes recording said inspection data including accompanying code and integrity data as a function of time and location within the system;

11. The method for certifying the plumbing system of a structure of claim 1 wherein said comparing step includes comparing the inspected data against the requirements in the template.

12. The method for certifying the plumbing system of a structure of claim 1 wherein said certification step includes certification that said plumbing system complies with the building and variations therefrom.

13. The method for certifying the plumbing system of a structure of claim 1 wherein said certification step includes certification that said plumbing system complies with the plumbing codes and deviations therefrom.

14. The method for certifying the plumbing system of a structure of claim 1 wherein said certification includes determination of system integrity including identification of breaches thereof.

15. The method for certifying the plumbing system of a structure of claim 1 wherein said inspecting step is carried out at least in part using an inspection tool, which comprises a multi-lensed camera, a digital distance tracking device, and a plumb-sensor, and a date time imager.

16. The method for certifying the plumbing system of a structure of claim 1 wherein said inspection tool communicates with a central consol by way of radio-frequency or fiber-optics and the video recording includes on each frame thereof a date, time, a distance, and an elevation based upon a starting point in the system, and comprises multi-views of the internal periphery, joints, “T”s, “Y”s of the system.

17. A method for certifying the plumbing code compliance and plumbing system integrity of a water supply, or ground water/storm sewer, or sewage/drainage system, which service a building structure comprising:
(a) populating a data base with building codes derived from the plumbing code authority having jurisdiction over said structure;
(b) generating plumbing code certification requirements for said structure from information in said database;
(c) inspecting the water supply, or ground water/storm sewer, or sewage/drainage system, based upon plumbing code certification requirements to produce inspection data;
(d) comparing said inspection data with said plumbing code certification requirements to produce information relative to said requirements to determine the compliance of the water supply, or ground water/storm sewer, or sewage/drainage system, with said pluming codes at the time the structure was erected, including updates;
(e) certifying said water supply, or ground water/storm sewer, or sewage/drainage system the condition of the system predicated upon a defined set of criteria to verify the compliance and integrity of the pluming system including identifying non-compliance and/or defects, if any.

18. The method for certifying of claim 17 wherein said code certification requirements are generated using updated building plans of said structure.

19. The method for certifying of claim 17 wherein said populating step includes populating a template with plumbing codes in the area in which the structure is located at the time the structure was erected and updates thereto applicable to said structure and identifying grand fathered provisions of said plumbing codes applicable to the structure.

20. The method for certifying of claim 17 wherein said inspecting step includes a visual inspection.

21. The method for certifying of claim 20 wherein said visual inspection is carried out by device for visual recording.

22. The method for certifying of claim 17 wherein said inspecting step further includes the use of sensors comprising pressure sensors, magnetic sensors, directional sensors, toxic gas sensors, hydrologic sensors, and combinations thereof.

23. The method for certifying of claim 17 wherein said inspection includes determination of conduit layout, grade obstructions, breaches in integrity and combinations thereof.

24. The method for certifying of claim 17 wherein said inspecting step includes recording said inspection data including accompanying code and integrity data as a function of time and location within the system.

25. The method for certifying of claim 17 wherein said certification includes determination of system integrity including identification of breaches thereof.

26. The method for certifying of claim 17 wherein said inspecting step is carried out, at least in part, using an inspection tool, which comprises a multi-lensed camera, a digital distance tracking device, a plumb-sensor, and a date time imager.

27. The method for certifying of claim 17 wherein said inspection tool communicates with a central consol by way of radio-frequency or fiber-optics and the video recording includes on each frame thereof a date, time, a distance, and an elevation based upon a starting point in the system, and comprises multi-views of the internal periphery, joints, “T”s, and “Y”s of the system.

28. The method for certifying of claim 17 wherein said drainage/sewage system is certified from the fixtures to the connection with the main sewer line interconnect or septic system.

29. The method for certifying of claim 17 wherein said ground water/storm sewer system is certified from the accumulating receptacle to the main sewer line.

30. The method for certifying of claim 17 wherein said water supply is certified from the water main to the fixtures.
